(19) United States
(12) Patent Application Publication
(10) Pub. No.: US 2009/0217532 A1
(43) Pub. Date: Sep. 3, 2009

(54) Food Delivery System and Methods

(76) Inventor: Homaro R. Cantu, Chicago, IL (US)

Correspondence Address: Valauskas & Pine, 150 South Wacker Drive, Suite 620, Chicago, IL, 60606, US

(21) Appl. No.: 12/224,157

(22) PCT Filed: Jan. 24, 2007
(86) PCT No.: PCT/US2007/001917

§ 371 Date: Feb. 9, 2009

Related U.S. Application Data
(60) Provisional application No. 60/761,687, filed on Jan. 24, 2006.

(51) Int. Cl. A47J 43/28

(52) U.S. Cl. 30/123

(57) ABSTRACT

The present invention generally relates to a system and methods by which the delivery of a food item for personal consumption may be facilitated. More specifically, the present invention is directed to systems and methods that include the use of simplified utensils by which food may be managed and prepared for consumption. Certain embodiments of the simplified utensils include one or flavoring retainers by which flavoring agents can be retained and conveyed to a diner or diners and the flavor of a food item altered during consumption of a food item.

This application claims priority from U.S. Provisional Application No. 60/761,687 filed Jan. 24, 2006.

### FIELD OF THE INVENTION

The present invention generally relates to a system and methods by which the delivery of a food item for personal consumption may be facilitated. More specifically, the present invention is directed to systems and methods that include the use of simplified utensils by which food may be managed and prepared for consumption. Certain embodiments of the simplified utensils include one or flavoring retainers by which flavoring agents can be retained and conveyed to a diner or diners and the flavor of a food item altered during consumption of a food item.

### BACKGROUND OF THE INVENTION

While people of some cultures rely on their hands as the principal means to contact food and convey it to their mouths for consumption, other cultures rely primarily on one or more utensils to accomplish the task.

The food utensils that are used by a culture can vary greatly. For example, people of China, Japan, Korea, and Vietnam traditionally have used generally equally shaped and sized sticks—commonly known as “chopsticks”—to manage food for consumption. Chopsticks can vary in length according to the task for which they are used (e.g., longer for cooking v. shorter for eating) and shape. (Chinese chopsticks taper slightly to a blunt end while Japanese chopsticks taper more to form a pointed end.) Chopsticks can be made from a variety of materials including wood, bamboo, and metal. They are operated with the thumb and fingers of one hand as tongs to pick up food to convey it to the mouth or to sweep food into the user's mouth or to create leverage—such as to separate edible portions from bones.

Rather than relying generally on different sizes and shapes of a single utensil design, Western cultures developed a line of food utensils over time. Knives are believed to have been used in the West since prehistoric days for eating food. While shells were used in these same prehistoric times to convey liquid to a consumer's mouth, other material—such as wood or horn—came to be shaped into a utensil having a concave portion —or bowl—and a handle for this purpose. For centuries, Western cultures relied on these two utensils—a knife and a spoon—for eating. It is believed that sometime during the Medieval or Early Renaissance period, Western cultures came to adopt a tool—the fork—that was earlier developed in the Middle East for eating. The early fork had a handle and two tines. With time, forks with more tines were developed. The fork further evolved with time. The pastry fork has a broad single tine—to cut, for example, cake—and two other tines to eat the cake as with any fork. The “spork” is a hybrid utensil combining a series of tines at the leading edge of a bowl so that the utensil can be used as a fork and a spoon. A “knork” is a combination of the tines of a fork and the cutting edge of a knife—such as found in a pastry fork.

Regardless of the utensil, the food item intended for consumption and any flavoring, spice, condiment or other element intended to complement flavor, texture, or other aspect of the main food item still remain separate from the utensil. As a result, the process of eating often requires having a component on which the food is placed or held during the eating process (such as a plate, bowl, or saucer), and one or more containers (such as bottles, boxes, or shakers) of the flavoring, spice, condiment, or other material that is intended to complement the main food item, plus the one or more utensils for the management and conveyance of the food item to the consumer's mouth. Storing all of these components, such that they were readily available for a consumer before, during and after the eating process, takes space. After the food is consumed, the components on which the food is placed so that the consumer can eat the food must be cleaned, dried, and returned to the storage area. This traditional method of consuming food is not only time consuming but also requires storage space such that all of the items can be made readily available.

A demand therefore exists for a utensil that facilitates the process of consuming food. The present invention satisfies the demand.

### SUMMARY OF THE INVENTION

The present invention generally relates to a system and methods by which the management of a food item for personal consumption may be facilitated. More specifically, the present invention is directed to systems and methods that include the use of simplified utensils by which food may be managed and prepared for consumption. Certain embodiments of the simplified utensils include one or flavoring retainers by which flavoring agents can be retained and conveyed to a diner or diners and the flavor of a food item altered for consumption of a food item. Other embodiments include a utensil including a storage component by which food can be stored and discharged.

An object of the present invention is to provide simplified system that facilitates the consumption of food.

Another object of the present invention is to provide a simplified system by which food may be flavored.

An added object of the present invention is to provide a simplified system for the storage of a food item and/or a flavoring element for the food.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A is an overhead drawing of a utensil according to the present invention including a flavoring retainer;

FIG. 1B is a side view of the embodiment shown in FIG. 1A;

FIG. 1C is a perspective view of the embodiment shown in FIGS. 1A and 1B;

FIG. 1D is a front view of the embodiment shown in FIGS. 1A-1C;

FIG. 2A is an overhead drawing of another embodiment of a utensil according to the present invention;

FIG. 2B is a side view of the embodiment shown in FIG. 2A;

FIG. 2C is a perspective view of the embodiment shown in FIGS. 2A and 2B;

FIG. 2D is a front view of the embodiment shown in FIGS. 2A-2C;

FIG. 3A is an overhead drawing of an additional embodiment of a utensil according to the present invention having tines;

FIG. 3B is a side view of the embodiment shown in FIG. 3A;

FIG. 3C is a perspective view of the embodiment shown in FIGS. 3A and 3B;

FIG. 3D is a front view of the embodiment shown in FIGS. 3A-3C;

FIG. 3E is an view from distal end of the embodiment shown in FIGS. 3A-3D;

FIG. 4A is an overhead drawing of an embodiment of a utensil according to the present invention having tines and a flavoring retainer;

FIG. 4B is a side view of the embodiment shown in FIG. 4A;

FIG. 4C is a perspective view of the embodiment shown in FIGS. 4A and 4B;

FIG. 4D is a front view of the embodiment shown in FIGS. 4A-4C;

FIG. 5A is an overhead drawing of another embodiment of a utensil according to the present invention and a flavoring retainer;

FIG. 5B is a side view of the embodiment shown in FIG. 5A;

FIG. 5C is a perspective view of the embodiment shown in FIGS. 5A and 5B;

FIG. 5D is a rear view of the embodiment shown in FIGS. 5A-5C;

FIG. 6A is an overhead drawing of an added embodiment of a utensil according to the present invention and a flavoring retainer;

FIG. 6B is a side view of the embodiment shown in FIG. 6A;

FIG. 6C is a perspective view of the embodiment shown in FIGS. 6A and 6B;

FIG. 6D is a rear view of the embodiment shown in FIGS. 6A-6C;

FIG. 7A is an overhead drawing of the embodiment of a utensil and a concave food management element;

FIG. 7B is a side view of an embodiment shown in FIG. 7A;

FIG. 7C is a perspective view of the embodiment shown in FIGS. 7A and 7B;

FIG. 8A is a front view of another embodiment of a utensil having a concave food management element;

FIG. 8B is a side cutaway view of the embodiment shown in FIG. 8A;

FIG. 8C is a perspective view of the embodiment shown in FIGS. 8A and 8B;

FIG. 9A is an overhead view of an added embodiment of a utensil having a flavoring retainer;

FIG. 9B is a side view the embodiment shown in FIG. 9A;

FIG. 9C is a perspective view of the embodiment shown in FIGS. 9A and 9B shown partially cutaway;

FIG. 9D is a front view of the embodiment shown in FIGS. 9A-9C;

FIG. 10A is a side view of an additional embodiment of a utensil having leading edges for management of a food item;

FIG. 10B is a side cutaway view of the embodiment shown in FIG. 10A;

FIG. 10C is a perspective view of the embodiment shown in FIGS. 10A and 10B;

FIG. 10D is a front view of the embodiment shown in FIGS. 10A-10C;

FIG. 11A is an overhead view of an embodiment of a utensil having a distal retainer;

FIG. 11B is a side view of the embodiment shown in FIG. 11A;

FIG. 11C is a perspective view of the embodiment shown in FIGS. 11A and 11B;

FIG. 11D is a front view of the embodiment shown in FIGS. 11A-11C;

FIG. 12A is a side view of an added embodiment of a utensil having spaced tines;

FIG. 12B is a rear view of the embodiment shown in FIG. 12A;

FIG. 12C is a perspective view of the embodiment shown in FIGS. 12A and 12B;

FIG. 12D is a front view of the embodiment shown in FIGS. 12A-12C;

FIG. 12E is another side view of the embodiment shown in FIGS. 12A-12D;

FIG. 13A is an embodiment of a utensil made from generally planar materials;

FIG. 13B is an embodiment of an edible utensil;

FIG. 13C is an embodiment of a utensil made from edible materials;

FIG. 14A is a front view of another embodiment of a utensil having a concave food management element;

FIG. 14B is a side cutaway view of the embodiment shown in FIG. 8A showing the plunger positioned fully within the chamber of the utensil;

FIG. 14C is a perspective view of the embodiment shown in FIGS. 14A and 14B showing the plunger extending from the distal end of the utensil; and

FIG. 15 is a perspective view of an embodiment of a utensil having a concave food management element and a clear chamber with graduations that show the fill and/or contents of the chamber.

### DETAILED DESCRIPTION OF PREFERRED EMBODIMENTS

A food management utensil—also termed simply “utensil” herein—according to the present invention is identified in the appended drawings as 21. The utensil 21 includes a body 22 having a proximate end 22A and a distal end 22B. The body 22 includes gripping area 31—by which the utensil 21 may be partially or wholly manipulated—and a food management element 71—by which a food item 221 (also termed “food” herein) can be managed for consumption such as altered in size or shape and/or flavored, colored, and/or spiced and/or heated or cooled, and/or retained and conveyed by cutting, jabbing, spooning, lifting, discharging, and/or extruding the food item.

Certain embodiments of the utensil 21 according to the present invention include a flavoring retainer 121 by which a flavor element 151 is positionable during the course of consumption of the food item 221 so that the flavor, color, texture, spice, content, or temperature of the food item 221 may be thereby altered.

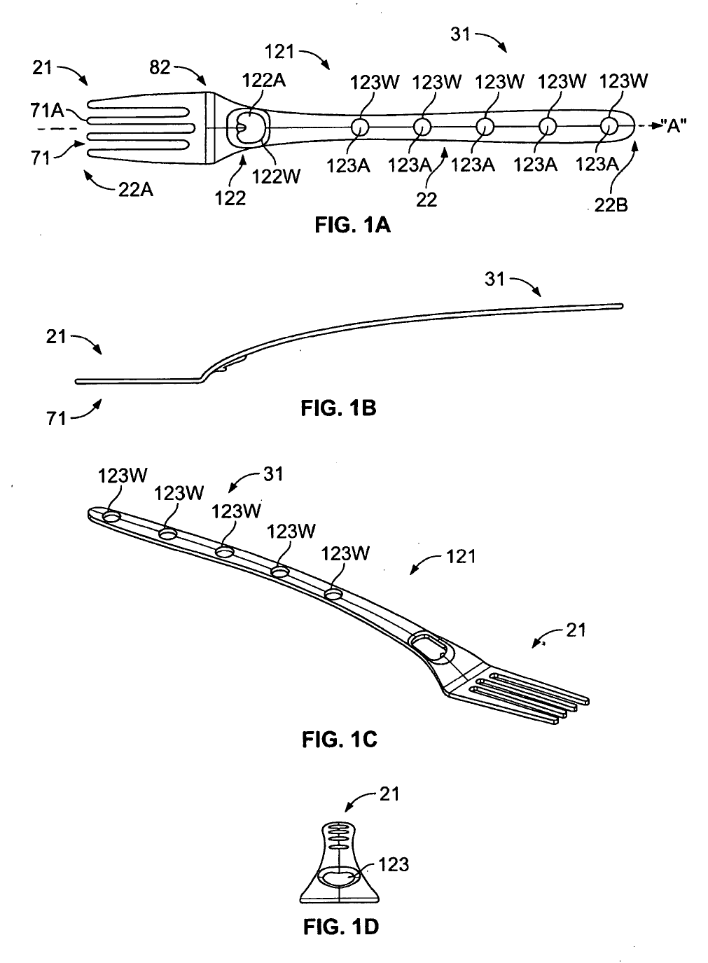

One preferred embodiment of the utensil 21 having a flavoring retainer 121 is shown in FIGS. 1A-1D. The embodiment of the utensil 21 shown in these drawings includes a food management element 71 having tines in a series 71A such that the utensil 21 may be used much in the same way a traditional fork is used to manage and deliver food 221 to a diner for consumption. In this embodiment, the flavoring retainer 121 is comprised of a proximate retainer 122—positioned generally close to the transition area 82 of the utensil 21—which separates the food management element 71 from the gripping area 31—and that, during the course of consumption of the food 221, will be brought in generally close contact with at least the diner's nose. In the FIG. 1A-1D embodiment, the proximate retainer 122 is shown as a proximate aperture 122A—defined by a proximate utensil wall 122W—having a size that is generally larger than the size of any one of the distal retainers 123 positioned generally in line with the axis “A” along which the gripping area 31 is aligned. Each of the distal retainers 123 in this embodiment includes a distal aperture 123A—positioned along the gripping area 31 and at a distance from the food management portion 72 of the utensil 21—that is defined in size and shape by a distal aperture wall 123W. A large size of the proximate retainer 122—relative to the distal retainers 123—permits a relatively larger flavor element 151—including garlic, cheese, chocolate, or other fragrant or flavor element—to be positioned within the proximate aperture 122A such that a fragrance or aroma may be more directly made available to the diner who uses the utensil 21. Smaller flavor elements 151—such as the same element 151 that may be inserted in the proximate retainer 122 or different flavor elements 151, such as an individual leaf or a small bunch of leaves of an herb—may be placed in the distal retainers 123. A flavor element 151 that exudes a fragrance or aroma upon being manipulated or crushed—such as herbs including thyme, basil, oregano, and lavender—will provide such fragrance or aroma during the course of a diner's use of the utensil because of the diner's manipulation of the gripping area 31 in which the distal retainers 123 are positioned.

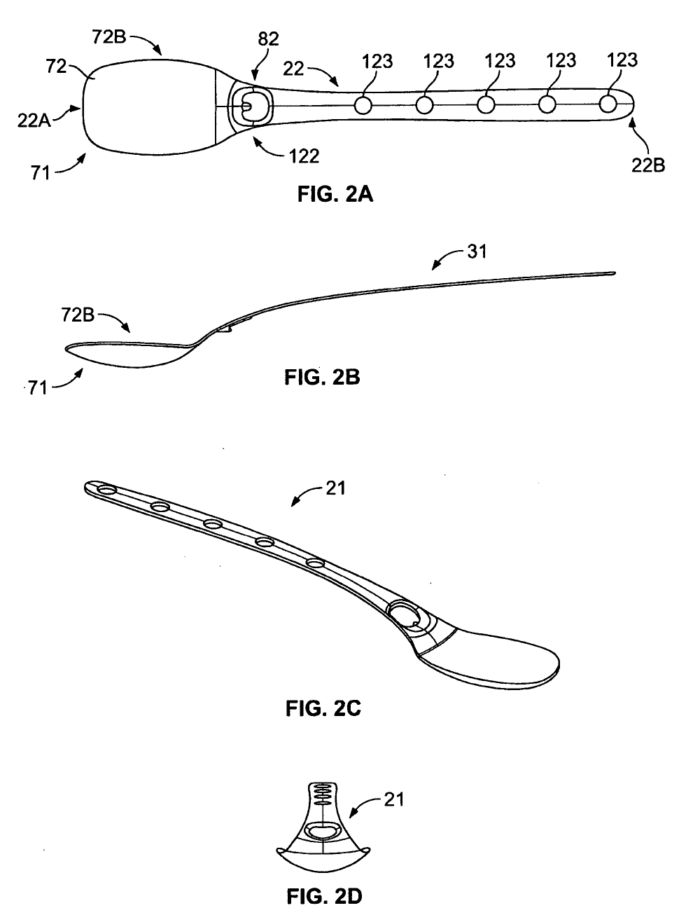

FIG. 2A through FIG. 2D show another embodiment of a utensil 21 that is very similar to the utensil shown in FIG. 1A through 1D except that the food management element 71 includes a food management surface 72 shaped to form a bowl 72B such that the utensil 21 may be used in ways similar to the ways a traditional spoon is used. As with the FIG. 1A through 1D embodiment, the utensil 21 shown in FIG. 2A through FIG. 2D includes a proximate retainer 122 and distal retainers 123.

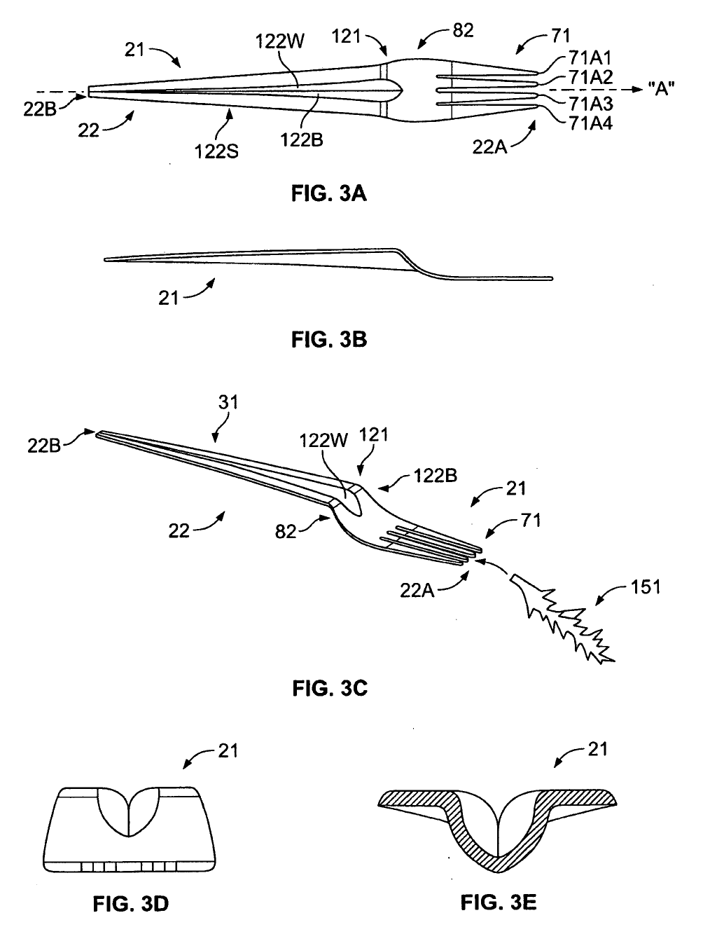

FIG. 3A through FIG. 3E show another embodiment of a utensil 21 according to the present invention in which the food management element 71 are tines 71A in a series 71A—such as 71A1, 71A2, 71A3, and 71A4—such that the utensil 21 may be used much in the same way a traditional fork is used to manage and deliver food 221 to a diner for consumption. Other embodiments of the utensil 21 may include a different number of tines 71A in the series. The FIG. 3A through 3E embodiment of the utensil 21 includes a flavoring retainer 121 by which a flavor element 151 (shown in FIG. 3C as a herblike portion) is positionable during the course of consumption of the food item 221 so that the flavor of the food 221 may be thereby altered. The flavoring retainer 121 of this embodiment is a proximate retainer 122 that includes a proximate utensil wall 122W that defines a trough-like shaped area 122B that extends from a transition area 82 generally adjacent to the food management element 71 and in line with the central axis “A” along which the gripping area 31 and the utensil 21 is aligned, narrowing as the proximate retainer 122 terminates at the distal end 22B of the utensil 21. The flavor element 151 that may be received in the illustrated flavoring retainer 121 may be, in addition to solid material (such as the illustrated herb, or cheese or garlic), oil or other agent—a powder, aroma, fragrance, or perfume brushed or sprayed in the flavoring retainer 121. Given the greater surface area 122S of this embodiment of the proximate retainer 122, a flavor element 151 positioned on it may produce a more powerful or longer lasting. fragrance or aroma relative to that which may be produced through use of a utensil having a smaller flavoring retainer 121.

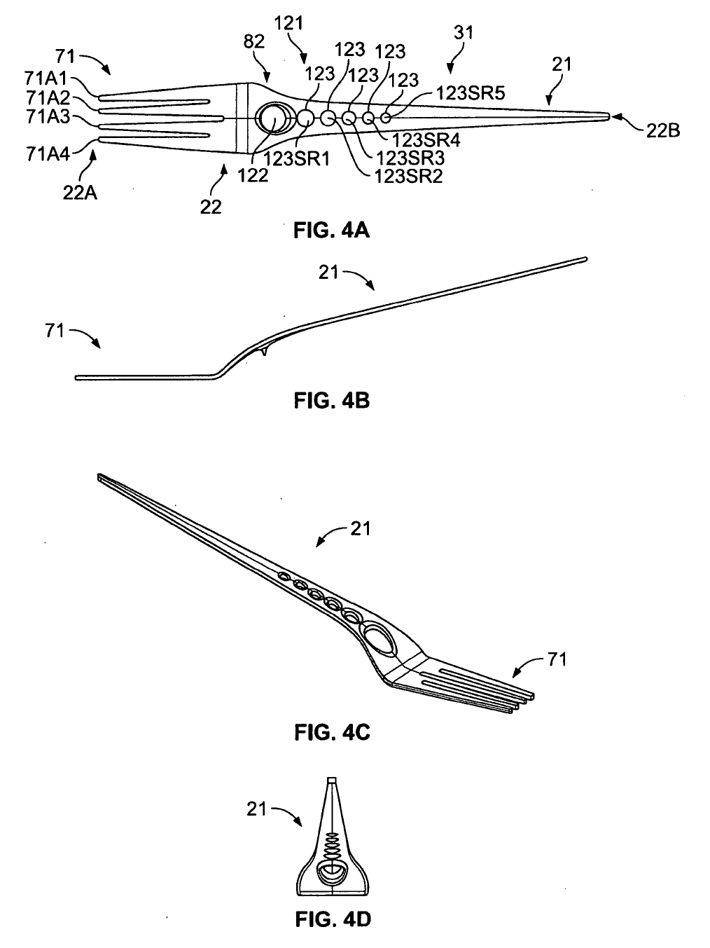

An additional preferred embodiment of a utensil 21 according to the present invention is shown in FIGS. 4A through 4D in which the food management element 71 also includes a series 71A of tines 71A1, 71A2, 71A3, and 71A4 such that the utensil 21 may be used much in the same way a traditional fork is used to manage and deliver food 221 to a diner for consumption. The FIG. 4A through 4D embodiment of the utensil 21 includes a flavoring retainer 121—similar to that which is shown in FIG. IA through FIG. 1D—having a proximate retainer 122 and distal retainer 123—the form of a series 123SR of retainers 123SR1, 123SR2, 123SR3, 123SR4, and 123SR5. The proximate retainer 122 is positioned generally close to the transition area 82 so that when the food management element 71 of the utensil 21 is brought to the diner's mouth during consumption of the food 221 that which is positioned within the proximate retainer 122 will be brought close to the diner's nose. The proximate retainer 122 is shown in this embodiment as being of a generally larger size than any one of the retainers in the series 123SR of distal retainers, such that the proximate aperture 122A may retain an appropriately sized flavor element 151 (not shown). The distal retainers in the series 123SR may gradually reduce in size as the series of retainers 125A approach the distal area 22B of the utensil 21 such as in the illustrated embodiment. The relatively larger size of the proximate aperture 122A permits a larger flavor element 151—including garlic, cheese, chocolate, or other fragrant or flavor element—to be brought in generally close contact with a diner's nose during the use of the utensil 21. Smaller-sized flavor elements 151 may be placed in one or more of the distal retainers 123—such as an individual leaf or a small bunch of leaves of an herb. The position of the series 123SR of distal retainers in the gripping area 31 and relatively closer to the transition area 82 makes it more likely that a diner during manipulation of the utensil 21 will come into repeated contact with that which is placed in the distal retainer.

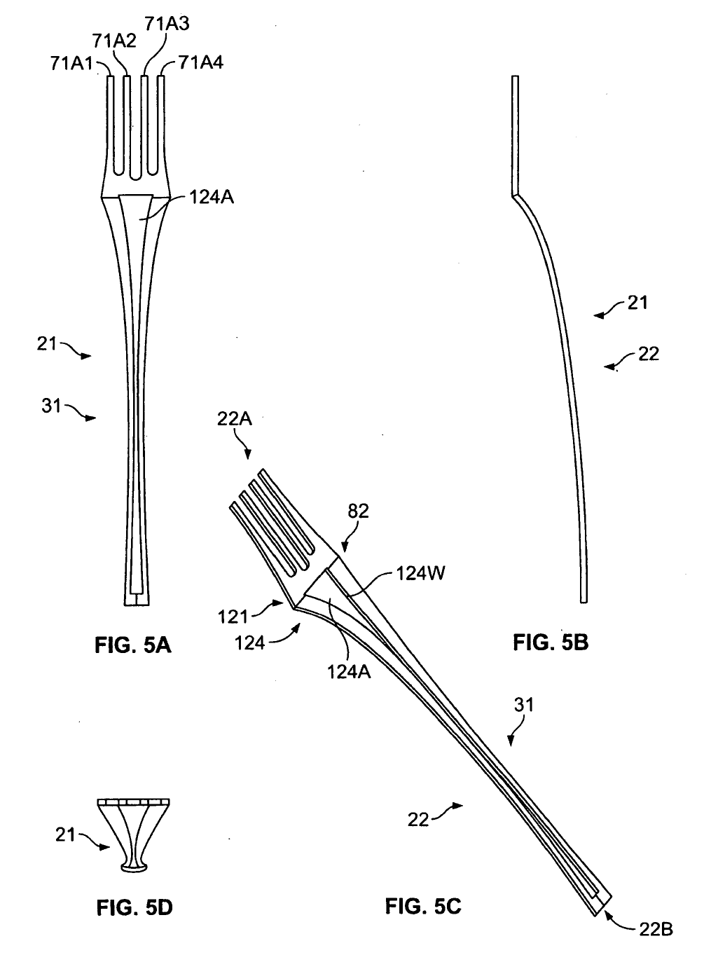

An added preferred embodiment of the utensil 21 is shown in FIGS. 5A through 5D and includes a flavoring retainer 121 in which the food management element 71 are also tines 71A in a series 71A1, 71A2, 71A3, 71A4 such that the utensil 21 may be used much in the same way a traditional fork is used to manage and deliver a food item 221 to a diner for consumption. This embodiment is similar to that utensil 21 which is shown in FIG. 1A through 1D and FIG. 4A through 4D but includes a flavoring retainer 121 that extends largely the length of the gripping area 31 of the utensil. The flavoring retainer 121 of the FIG. 5A through FIG. 5D embodiment is an extended retainer 124 that includes an extended retainer wall 124W that defines an extended retainer aperture 124A which extends from a portion at the transition area 82 and toward the distal point 22B of the utensil 21. A flavoring retainer 121 such as this one permits a wide range of flavoring agents 151 to be inserted therein, including relatively larger fragrant and flavorful materials.

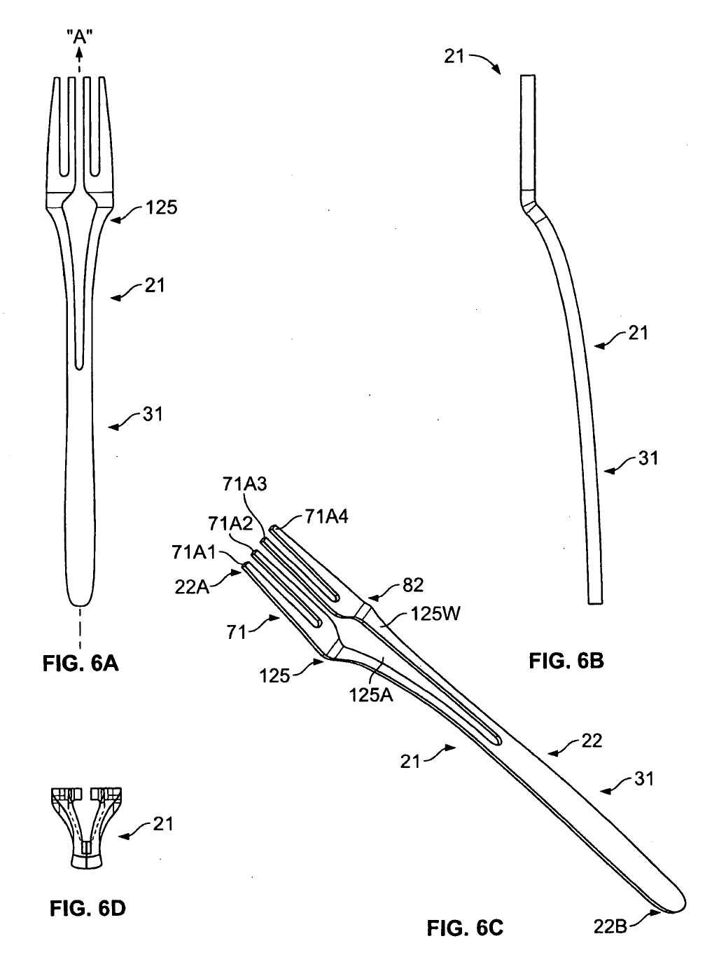

An additional preferred embodiment of the utensil 21 having a flavoring retainer 121 is shown in FIGS. 6A through 6D in which the food management element 71 are tines 71A in a series 71A1, 71A2, 71A3, 71A4 such that the utensil 21 may be used much in the same way a traditional fork is used to manage and deliver food 221 to a diner for consumption. In the FIG. 6A through 6D embodiment of the utensil 21, the flavoring retainer 121 is a proximately extended retainer 125 that includes a proximately extended retainer wall 125W that defines a proximately extended retaining aperture 125A that opens through the tines 71A, expands distally through the transition area 82, then as it extends along an axis “A” toward the distal end 22B narrows through the gripping area 31. The proximately extended retaining aperture 125W provides separation 74 of the tines 71A of the illustrated utensil 21 and a variable-sized space produced by the aperture 125A for retention of one or more of a variety of flavor elements 151.

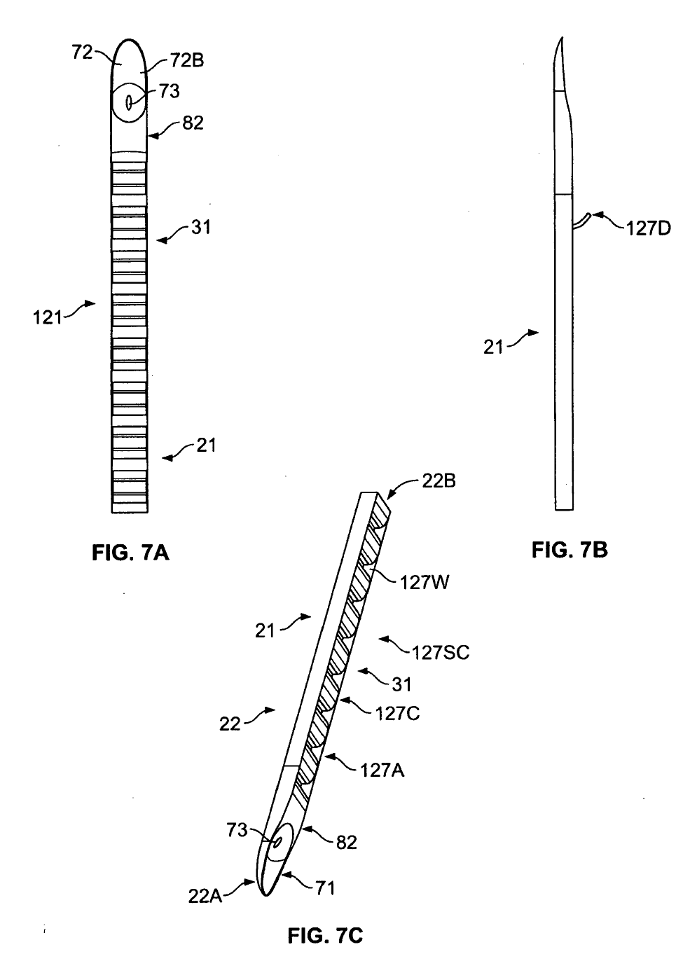

FIGS. 7A through FIG. 7C illustrate another embodiment of a utensil 21 that includes having a flavoring retainer 121 and a food management element 71. The food management element 71 includes a food management surface 72 sized and shaped to form a bowl 72B such that the utensil 21 may be used in ways similar to the ways a traditional spoon is used. The flavoring retainer 121 in the illustrated embodiment is in the form of a flavoring retention chamber 127 which is defined in part by a chamber wall 127W opening within the gripping area 31. Within the chamber wall 127W one or more chambers 127C may be positioned. In the embodiment of the utensil 21 shown in FIGS. 7A through 7C, a plurality of chambers 127C are positioned in a series of chambers 127SC that they extend from the transition area 82 and toward the distal end 22B along the gripping area 31 of the utensil 21. One or more of the chambers 127SC within the chamber series 1275C of the illustrated embodiment is sized and shaped to receive and retain one or more different flavor elements 151—such as a relatively larger solid material or one or more fragrant or aromatic materials in smaller form, such as in granular or powder form including a seasoning, sauce, or condiment, or an oil. The flavor element 151 may be discharged from one or more of the chambers 127C and enter, for the food management surface 72 such as through the aperture 73 opening from the area 127A defined by the chamber wall 127W and the surface 72. To facilitate such discharge, the gripping wall 31 may be generally flexible and one or more of the chambers 127C may include a chamber wall 127W that may be disrupted by, for example, pressure applied to the wall 127W by pressure being applied to the gripping wall 31 such that the chamber 127C opens and the flavor element 151 is received within the area 127A. The flavor elements 151—having a relatively smaller size, such as in small granular form or as a powder, or in liquid form—may enter on or around the food management surface 72 of the food management area 71 through a discharge aperture 73. Alternatively, one or more of the chambers 127C may include one or more doors 127D that may open (such as shown in FIG. 7B) in response to manipulation by a user of the utensil 21—such as of the gripping wall 31—to permit the flavor element 151—at least in part—to enter on or around the surface 72. One or more of the chambers 127C may be baffled to produce a stronger aroma during use of the utensil 21. By manipulation of the gripping area 31 or one or more of the chambers 127C, the chambers 127C may be removable from the utensil 21 for individual manipulation by the user and application of flavoring, spice, texture or temperature. In such a separable embodiment of the one or more chambers 127C, the chambers may include little or no covering of the flavor element 151 so that the flavor element 151 may be used with little or no other effort by the diner.

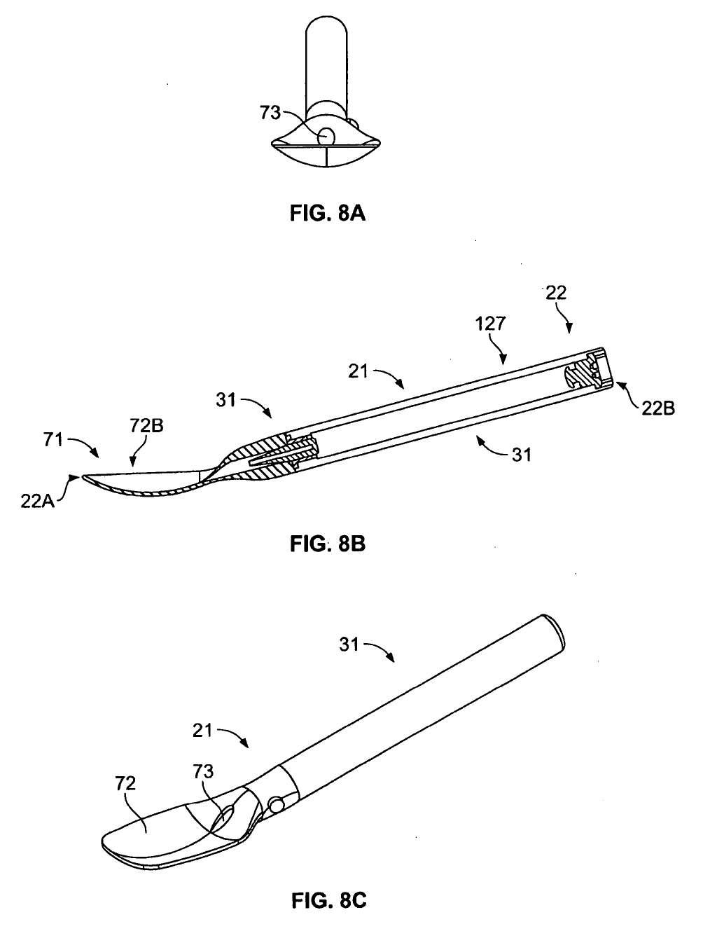

FIGS. 8A through FIG. 8C show another embodiment of a utensil 21 having a flavoring retainer 121 in which the food management element 71 includes a surface 72 forming a bowl 72B such that the utensil 21 may be used in ways similar to the ways a traditional spoon is used. The utensil 21 includes a single flavoring retention chamber 127 within the gripping area 31 of the utensil 21 for the storage of a food item 221 or a flavor element 151 such that it may be readily discharged. The chamber can be charged with a neutral gas thereby permitting food 221 or the flavoring element 121 within the chamber to be discharged through the aperture 73.

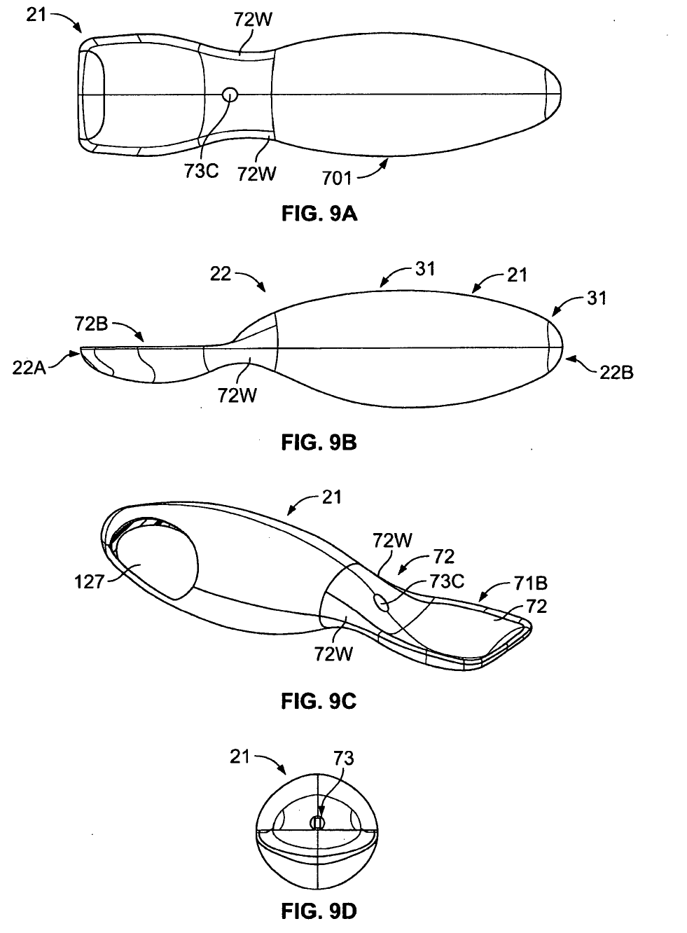

FIG. 9A through FIG. 9D show a similar embodiment of a utensil 21 having a flavoring retainer 121 in which the food management element 71 includes a surface 72 forming a bowl 72B such that the utensil 21 may be used in ways similar to the ways a traditional spoon is used. The illustrated embodiment of the utensil 21 includes a chamber 127 within the gripping area 31 of the utensil 21 (shown in FIG. 9C) in which food item 221 or a flavor element 151 may be stored for discharge such as onto or around the surface 72 through a discharge aperture 73. The discharge of the flavor element 151 may be facilitated by the application of pressure to the gripping wall 31 of the utensil 21 in those embodiments of the utensil 21 in which the gripping wall 31 is generally flexible. As in embodiments of the utensil 21 of the FIGS. 8A through 8C embodiment, the chamber 127 may also be charged with a neutral substance that does not affect the flavor or taste of the food item 221 or flavor element 151 and by application of pressure—to the side walls 72W of the transition area 72 (in the embodiments in which the side walls are flexible) the aperture 73 (which a flexible closure 73C covers) may open for such discharge. FIG. 9D shows the embodiment of the utensil 21 with the cover 73C open to provide aperture 73. FIGS. 9A and 9C show the flexible cover 73C closed.

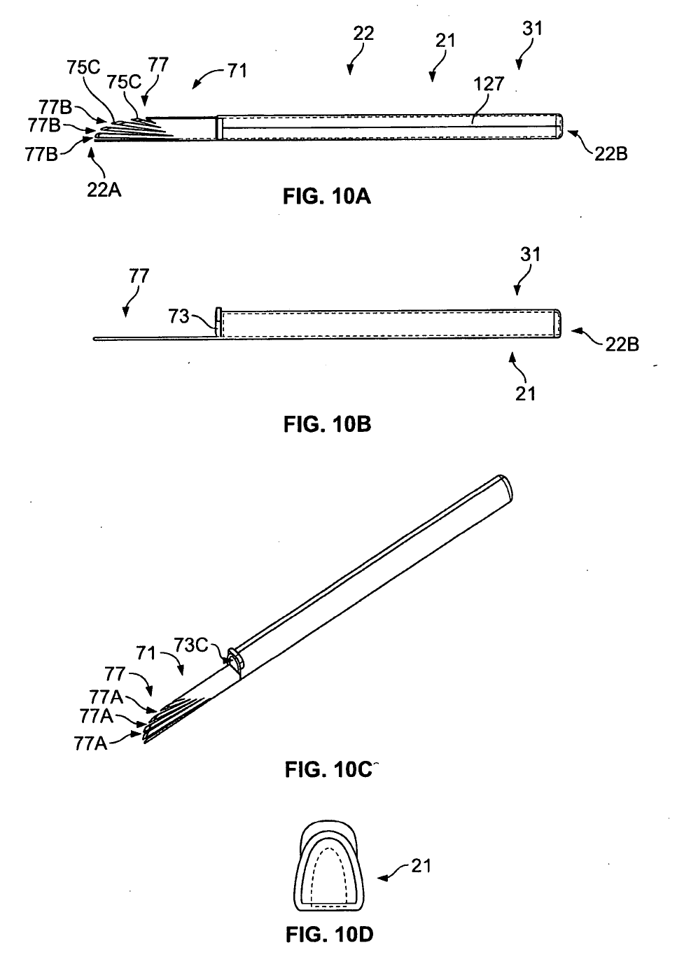

FIGS. 10A through FIG. 10D illustrate embodiments of a utensil 21 having a flavoring retainer 121 in which the food management element 71 advantageously includes multiple management elements 77 that permit the utensil to function as a traditional fork or knife does or as chopsticks do. Specifically, the multiple management elements 77 include leading edges 77A by which a food item 221 may be cut, management spacing 77B that permit food 221 to be wedged thereinbetween as a pair of chopsticks are used, and tine-like elements 75C so that food 221 may be placed thereon and lifted to a diner's mouth. The FIGS. 10A through 10D embodiment of utensil 21 also may include a chamber 127 in which food item 221 or a flavor element 151 may be stored for discharge such as onto the food management element 71. The illustrated embodiment of the utensil 21 may include a aperture cover 73C that through manipulation by the diner (shown partially open in FIG. 10B) may be opened to provide aperture 73 so to discharge flavor element 151 or food 221 on or about the food management element 71.

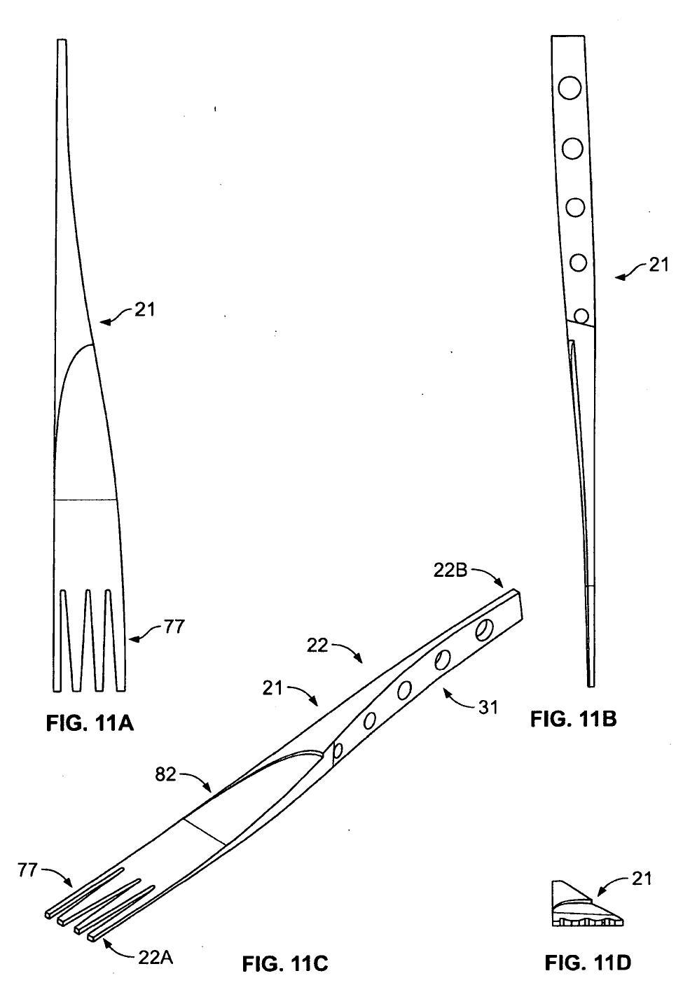

FIGS. 11A through FIG. 11D illustrate another embodiment of a utensil 21 having a flavoring retainer 121 in which the food management element 71 advantageously includes tine-like management elements 77 that permit the utensil to function as a traditional fork does. In the illustrated embodiment of the utensil 21, the flavoring retainer 121 is a distal retainer 123 extending from the gripping area 31 distant from the transition area 82 and food management area 71 but positioned such that the flavor elements 151 are touched and abraded by the diner's hand during manipulation of the utensil 21.

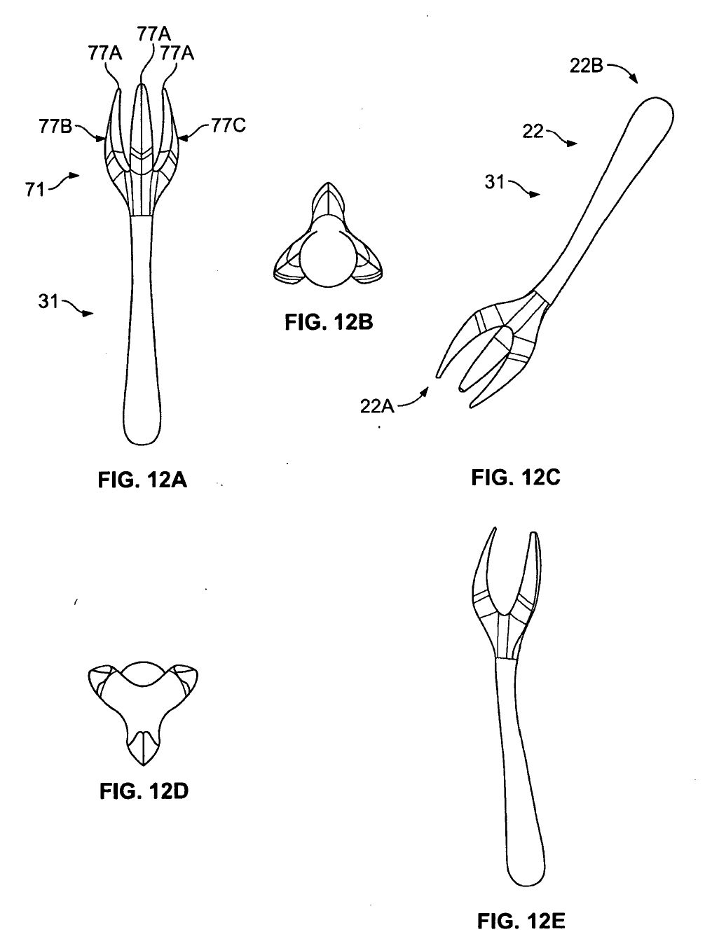

FIGS. 12A through FIG. 12E show another embodiment of a utensil 21 advantageously including management elements 75 that permit the utensil to function in certain uses as a traditional fork is used. The FIGS. 12A through 12E embodiment of utensil 21 include a food management element 71 that includes spaced tines 77 that include pointed ends. 77A and, with respect to at least certain of the tines, a sharpened edge 77B or a serated edge 77C.

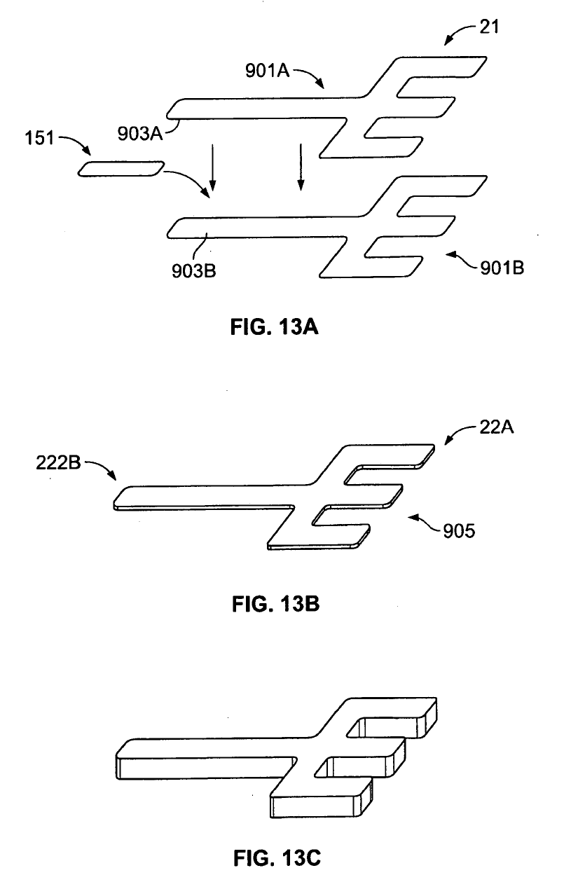

FIGS. 13A and 13B show an embodiment of a utensil that can be formed from generally planar materials 901A, 901B joined together such that at least some appreciable moisture is retained within the materials 901A, 901B or on one or more inner surfaces 903A, 903B. Certain preferred embodiments include a flavor element 151 having a size and shape such that it may be inserted between the generally planar materials 901A, 901B and on one or more of the inner surfaces 903A, 903B. Upon joining of the planar materials 901A, 901B to form a planar unit 905 (shown in FIG. 13B) and application of heat or other processing—including microwaving, the utensil 21 may expand and adopt the desired shape as shown in FIG. 13C. In those embodiments in which the planar materials 901A, 901B are made from edible substances—including potato, corn, tapioca or other starch, the entire utensil 21 may be consumed.

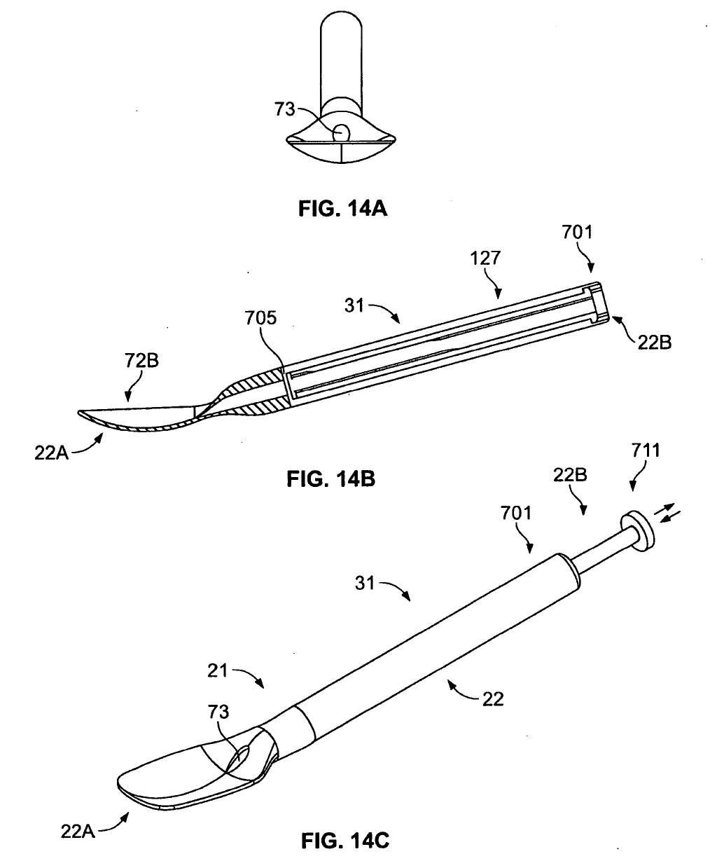

FIG. 14A through 14C show another embodiment of a utensil 21 having a flavoring retainer 121 in which the food management element 71 includes a surface 72 forming a bowl-like shape 72B such that the utensil 21 may be used in ways similar to the ways a traditional spoon is used. The illustrated embodiment of the utensil 21 includes a single flavoring retention chamber 127 (shown in FIG. 14B) within the gripping area 31 of the utensil 21 for the storage of a food item or a flavor element 151 such that it may be readily discharged. The illustrated embodiment of the utensil 21 includes a system 701 for managing the contents 705 of the chamber 127 (shown partially in FIG. 14B). The contents 705 may be food 221 and/or a flavor element 151. The system 701 illustrated in the FIGS. 14A through 14C embodiment includes a plunger 711 which by withdrawing it from the chamber 127 as shown in FIG. 14C contents 705 may be drawn through the aperture 73 and into the chamber 127. By depressing the plunger 711, the contents 705 may be discharged through the aperture 73 for consumption. This embodiment advantageously permits the diner to flavor a food item 221 through application of a flavor element 151 or to discharge the food item 221 that is intended for consumption.

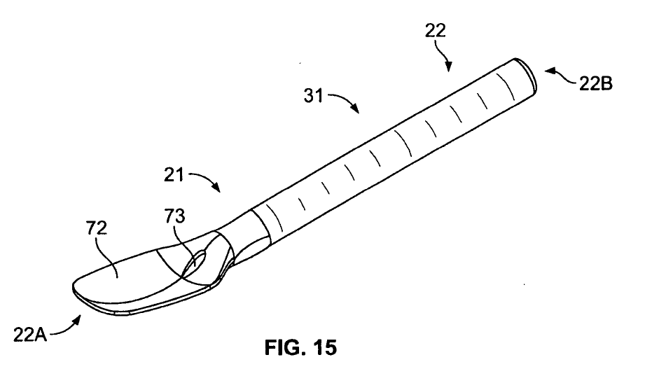

FIG. 15 illustrates another embodiment of the utensil in which the gripping area 31 is sufficiently clear so that a user can determine whether and to what extent the chamber 127 is filled. This embodiment of the utensil 21, can include a system 701 for managing the contents of the chamber 127 such as a plunger 711 or a gas discharged system by the manipulation of which the food or flavor element can be discharged from the chamber 127 and onto the surface 72 for consumption.

It will be understood that the embodiments of the present invention which have been described are illustrative of some of the applications of the principles of the present invention. Numerous modifications may be made by those skilled in the art without departing from the true spirit and scope of the invention.

what is claimed is:

1. A utensil comprising:
a food management element for manipulation of a food item; and
a flavoring retainer sized and shaped and positioned to permit a flavor element to produce a flavor or aroma such that when said food management element is brought close to a diner's mouth for consumption of the food item the produced flavor or aroma may be detected by the diner.

2. A flavor altering utensil, said utensil comprising:
a food management portion;
a gripping portion;
said gripping portion including a flavoring retainer with which a flavor element may be retained for altering flavor of a food item; and
said flavoring retainer having surface sized and shaped for receipt of at least a portion of the flavor element such that the flavor element may be retained in a position that a user can make sensory contact with the flavor element.

3. The flavor altering utensil according to claim 2 wherein said food management portion and said gripping portion are aligned generally along a common axis.

4. A utensil for altering flavor of a food item, said utensil comprising:
a food management portion for managing the food item, said food management portion aligned at a food management portion axis;
a gripping portion aligned along a gripping portion axis;
said food management portion axis positioned relative to said gripping portion axis at angle of less than 180°; and
said gripping portion including a flavor retainer sized and shaped for retention of at least a portion of a flavor element for altering the flavor of the food item.

5. The utensil according to claim 4, wherein said flavor retainer includes one or more chambers for retention of said flavor element or the food item.

6. A method by which a consumer may alter flavor of a food item, said food flavor altering method comprising:
inserting a flavor altering element in a flavoring retainer formed as a part of a flavor alteration utensil, the flavor alteration utensil including a food management portion by which the food item may be managed by the consumer and a gripping portion by which the consumer may grip the flavor alteration utensil, the gripping portion including the flavoring retainer in which the flavor altering element is inserted; and
engaging the flavor alteration utensil so that the flavor of the food item is altered for the consumer.

7. The food flavor alteration method according to claim 6, wherein said insertion step includes also positioning the flavor altering element within the flavor retainer so that the consumer comes into sensory contact with the flavoring altering element upon said engaging of the flavor alteration utensil.
